(19) United States
(12) Patent Application Publication
(10) Pub. No.: US 2006/0072772 A1
(43) Pub. Date: Apr. 6, 2006

(54) Piezoelectric loudspeaker

(76) Inventor: Shmuel Melman, Tel Aviv-Yafo (IL)

Correspondence Address: DARBY & DARBY P.C., P. O. BOX 5257, NEW YORK, NY, 10150-5257, US

(21) Appl. No.: 10/524,165

(22) PCT Filed:
(86) PCT No.: PCT/IL03/00660

Related U.S. Application Data
(60) Provisional application No. 60/402,241, filed on Aug. 8, 2002.

(51) Int. Cl. H04R 25/00

(52) U.S. Cl. 381/190

(57) ABSTRACT

A loudspeaker (8), including a piezoelectric disk (10) having a first diameter and a diaphragm disk (12) which is fixed to the second diameter greater than the first diameter. The loudspeaker further includes a cover (14), consisting of a convex surface (24) bounded by an annulus (26, 27), which mates with the diaphragm disk to form a generally plano-convex volume (28) between the diaphragm disk and the cover. A labyrinth (16, 18) is fixedly coupled to a circumference of the annulus to provide a path (34) for sound waves.

### CROSS-REFERENCE TO RELATED APPLICATION

This application claims the benefit of U.S. Provisional Patent Application 60/402,241, filed Aug. 8, 2002, which is incorporated herein by reference.

### FIELD OF THE INVENTION

The present invention relates generally to loudspeakers, and specifically to loudspeakers using piezoelectric disks.

### BACKGROUND OF THE INVENTION

Loudspeakers which use piezoelectric disks are well known in the art. In order to improve the performance of the disks, it is known to bond a plane diaphragm to the disk. Such a piezoelectric disk bonded to a plane diaphragm is described in U.S. Pat. No. 4,979,219 to Lin, whose disclosure is incorporated herein by reference. However, the combination of the plane diaphragm and the piezoelectric disk is not an efficient energy transducer, and significant energy is wasted in generating sound with such a combination.

### SUMMARY OF THE INVENTION

Preferred embodiments of the present invention provide a significant improvement in loudspeaker efficiency by mating a plane diaphragm, to which a piezoelectric disk has been bonded, to a preformed cover. The cover is a “one-piece” element comprising a section of a sphere, surrounded at a circumference of the section by an annulus. Mating such a cover with the bonded piezoelectric disk-diaphragm significantly increases the sound energy radiated by a loudspeaker at all frequencies at which the piezoelectric disk vibrates, compared to systems with no such cover.

The disk-diaphragm mates with the section of the sphere to form a substantially closed plano-convex volume. The plano-convex volume acts as a resonant cavity, and the cavity improves the efficiency of sound energy-electrical energy conversion. Conversion efficiency is also improved because of the larger surface area of the sphere section compared to both the piezoelectric disk and the diaphragm.

Preferably, an internal surface of the cover comprises a groove at the circumference of the section. The groove is adapted to receive and hold the disk-diaphragm in a “push-fit” manner, so that when it is so positioned, the disk-diaphragm and the section of the sphere form the substantially closed plano-convex volume. Alternatively, the disk-diaphragm and the cover, herein termed an actuator, are mated by other suitable means.

In some preferred embodiments of the present invention, the annulus surrounding the plano-convex volume has a substantially linear cross-section. Alternatively, the annulus has an at least partially sinusoidal cross-section.

In order to form the loudspeaker, the actuator is fixed to the base of a labyrinth. The labyrinth provides a path for sound waves from the actuator to “open air” beyond the loudspeaker, and also acts to match the impedance of the actuator to the open air. The actuator is most preferably also fixed to the labyrinth in a push-fit manner, so that the complete loudspeaker may be quickly and simply assembled.

Since the actuator acts as a two-way energy transducer, the loudspeaker may also be adapted to function as a microphone. When acting as a microphone, similar improvements in energy transfer to those for the loudspeaker, are achieved, compared to microphones without the actuator.

There is therefore provided, according to a preferred embodiment of the present invention, a transducer, including:

a piezoelectric disk having a first diameter;

a diaphragm disk, fixed to the piezoelectric disk, the diaphragm disk having a second diameter greater than the first diameter; and

a cover, having a convex surface bounded by an annulus, which mates with the diaphragm disk to form a generally plano-convex volume between the diaphragm disk and the cover.

Preferably, a cross-section of the annulus is substantially linear; alternatively a cross-section of the annulus includes a sinusoid.

Preferably, the convex surface includes an internal circumference, having a diameter substantially equal to the second diameter, and a groove formed along the internal circumference, and the diaphragm disk is retained in contact with the cover by the groove.

The transducer is preferably operative to convert electrical signals applied to the piezoelectric disk to sound waves radiated by the cover. Alternatively or additionally, the transducer is operative to generate electrical signals from the piezoelectric disk responsive to sound waves incident on the cover.

The diaphragm disk is preferably fixed substantially in parallel with and symmetrically to the piezoelectric disk, and the diaphragm disk, the piezoelectric disk, and the cover include a common axis of symmetry.

There is further provided, according to a preferred embodiment of the present invention, a loudspeaker, including:

a piezoelectric disk having a first diameter;

a diaphragm disk, fixed to the piezoelectric disk, the diaphragm disk having a second diameter greater than the first diameter;

a cover, having a convex surface bounded by an annulus, which mates with the diaphragm disk to form a generally plano-convex volume between the diaphragm disk and the cover; and

a labyrinth, which is fixedly coupled to a circumference of the annulus, and which is operative to provide a path for sound waves.

Preferably, a cross-section of the annulus is substantially linear; alternatively, a cross-section of the annulus comprises a sinusoid.

Preferably, the convex surface includes an internal circumference, having a diameter substantially equal to the second diameter, and a groove formed along the internal circumference, and the diaphragm disk is retained in contact with the cover by the groove.

Preferably, the piezoelectric disk is operative to convert electrical signals applied thereto to sound waves, and the sound waves are radiated by the cover. Alternatively or additionally, the piezoelectric disk is operative to generate electrical signals responsive to sound waves incident on the cover, so that the loudspeaker acts as a microphone.

Preferably, the diaphragm disk is fixed substantially in parallel with and symmetrically to the piezoelectric disk, and the diaphragm disk, the piezoelectric disk, the cover, and the labyrinth have a common axis of symmetry.

There is further provided, according to a preferred embodiment of the present invention, a method for converting between sound and electrical energy, including:

providing a piezoelectric disk having a first diameter;

fixing a diaphragm disk to the piezoelectric disk, the diaphragm disk having a second diameter greater than the first diameter; and

mating a cover, consisting of a convex surface bounded by an annulus, with the diaphragm disk to form a generally plano-convex volume between the diaphragm disk and the cover.

Preferably, the convex surface includes an internal circumference, having a diameter substantially equal to the second diameter, and a groove formed along the internal circumference, and the method further includes retaining the diaphragm disk in contact with the cover by the groove.

There is further provided, according to a preferred embodiment of the present invention, a method for forming a loudspeaker, including:

providing a piezoelectric disk having a first diameter;

fixing a diaphragm disk to the piezoelectric disk, the diaphragm disk having a second diameter greater than the first diameter;

mating a cover, consisting of a convex surface bounded by an annulus, with the diaphragm disk to form a generally plano-convex volume between the diaphragm disk and the cover; and

fixedly coupling a labyrinth to a circumference of the annulus, the labyrinth being operative to provide a path for sound waves.

Preferably the convex surface includes an internal circumference, having a diameter substantially equal to the second diameter, and a groove formed along the internal circumference, and the method further includes retaining the diaphragm disk in contact with the cover by the groove. The method preferably further includes forming a labyrinth groove in the labyrinth, and retaining the annulus in the labyrinth groove.

The present invention will be more fully understood from the following detailed description of the preferred embodiments thereof, taken together with the drawing, a brief description of which follows.

### BRIEF DESCRIPTION OF THE DRAWINGS

FIG. 1 is a schematic “exploded” illustration of a piezoelectric loudspeaker, according to a preferred embodiment of the present invention;

FIG. 2 shows schematic views of the piezoelectric loudspeaker of FIG. 1 as assembled, according to a preferred embodiment of the present invention;

FIG. 3 shows schematic views of an actuator of the piezoelectric loudspeaker of FIG. 1, according to a preferred embodiment of the present invention; and

FIG. 4 shows schematic views of an alternative actuator of the piezoelectric loudspeaker of FIG. 1, according to a preferred embodiment of the present invention.

### DETAILED DESCRIPTION OF PREFERRED EMBODIMENTS

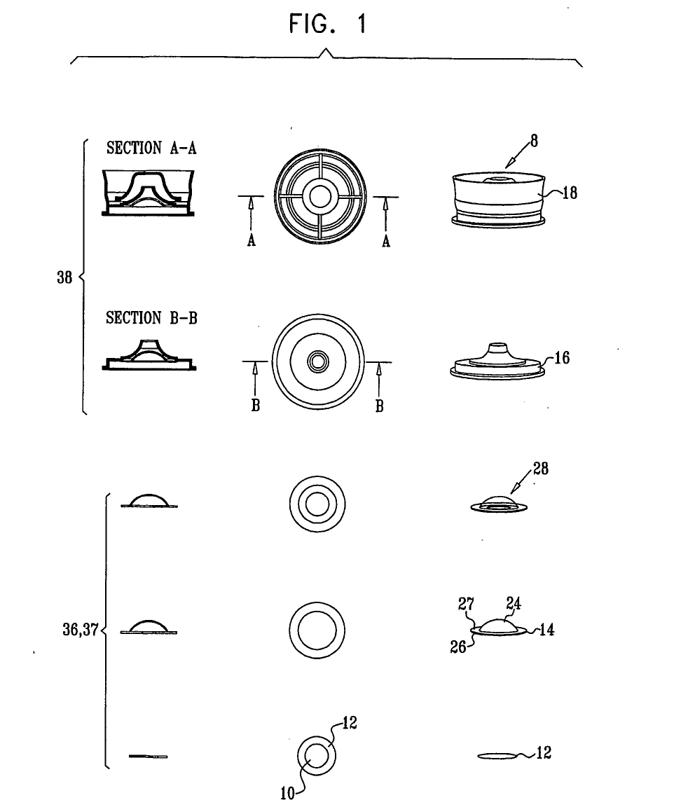

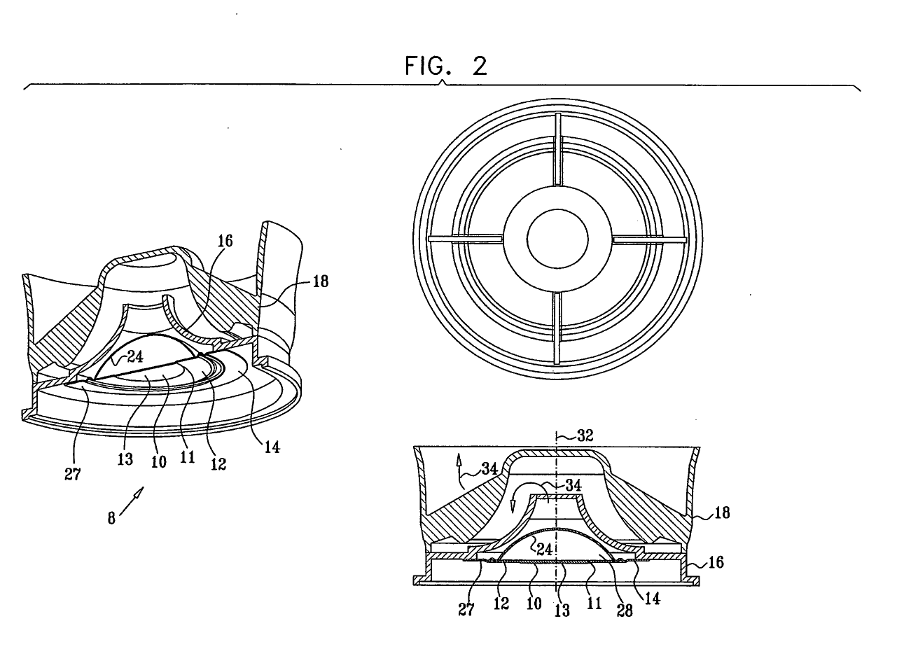

FIG. 1 is a schematic “exploded” illustration of a piezoelectric loudspeaker 8, and FIG. 2 shows schematic views of the piezoelectric loudspeaker as assembled, according to a preferred embodiment of the present invention. In the present disclosure, common identifying numbers in the figures correspond to common elements. An upper surface 11 of a piezoelectric disk 10 is bonded to an electrically conducting diaphragm 12, the diaphragm acting as a first electrode for the disk and acting also to increase an area from which sound energy is radiated. A second electrode (not shown for clarity in the figures) is coupled to a lower surface 13 of the piezoelectric disk.

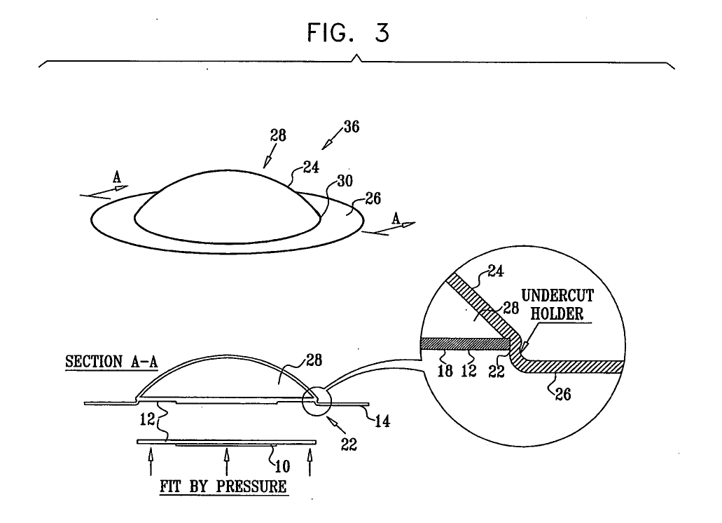

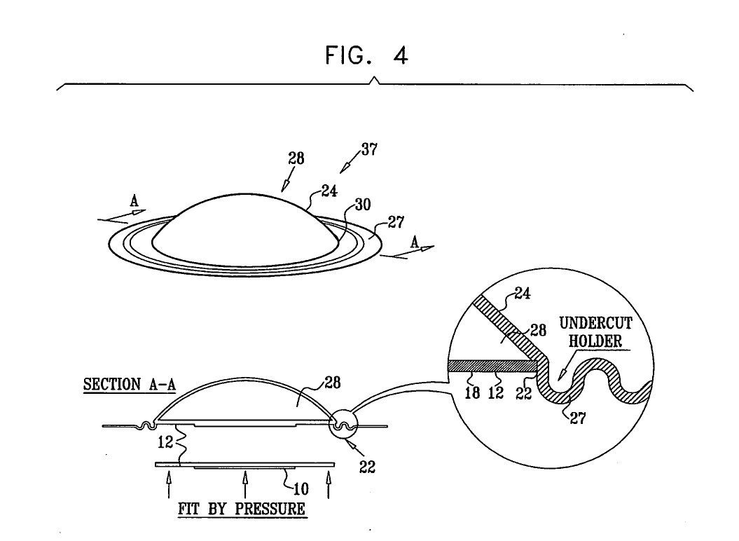

A one-piece cover 14 is formed, consisting of a section 24 of a sphere surrounded by an annulus 26 which preferably has a substantially plane cross-section. Alternatively, cover 14 comprises section 24 surrounded by an annulus 27 having an at least partially sinusoidal cross-section, also termed herein a wavy cross-section. (FIG. 3 and FIG. 4, described below, show more detail of cover 14, annulus 26, and annulus 27.) Section 24 has the form of a solid of rotation which is generated when a minor arc is rotated about its axis of symmetry. The circumference of spherical section 24 is implemented to have substantially the same diameter as a diameter of diaphragm 12. Most preferably, the cover is implemented from a hard plastic such as an acrylic or polycarbonate, although any other suitable solid material which is able to retain its shape may be used.

By way of example disk 10 has a diameter of approximately 25 mm and a thickness of approximately 0.2 mm; diaphragm 12 has a diameter of approximately 40 mm and a thickness of approximately 0.5 mm; cover 14 has an external diameter of approximately 60 mm, and a diameter of the spherical section is approximately 40 mm, to mate with the diaphragm, and section 24 protrudes approximately 10 mm above annulus 26 or 27. It will be appreciated, however, that the scope of the present invention comprises other dimensions of the disk, diaphragm, and cover. An actuator 36 for loudspeaker 8 comprises cover 14 with annulus 26, with bonded piezoelectric disk 10 and diaphragm 12. An actuator 37 for loudspeaker 8 comprises cover 14 with annulus 27, with bonded piezoelectric disk 10 and diaphragm 12.

FIG. 3 shows schematic views of actuator 36, and FIG. 4 shows schematic views of actuator 37, according to preferred embodiments of the present invention. Actuator 36 is generally similar in construction and operation to actuator 37; however, actuator 36 comprises annulus 26, actuator 37 comprises annulus 27. Cover 14 is preferably provided with a slight internal undercut 22 at an internal circumference of the spherical section, so that diaphragm 12 is mated with the cover by pushing the diaphragm into internal undercut 22. Once mated with the spherical section, undercut 22 holds diaphragm 12 fixedly and stably to cover 14. It will be appreciated that mounting the diaphragm to the cover using an undercut is a simple but extremely effective way of mating the two elements to form a mechanically stable combination.

Diaphragm 12 when mated with cover 14 thus forms a generally plano-convex air volume 28, substantially similar in shape to a plano-convex lens. Annulus 26 and annulus 27 protrude from a circumference 30 of volume 28, and lie in approximately the same plane as a plane comprising the diaphragm. It will be appreciated that piezoelectric disk 10, diaphragm 12, annulus 26 or annulus 27, and plano-convex volume 28 all have a common axis of symmetry 32 (FIG. 2).

Returning to FIGS. 1 and 2, actuator 36 or 37 is mounted to a first labyrinth element 16, the element being generally in the form of an inverted open curved cone. Preferably, the mounting is by providing an undercut on the underside of element 16, the undercut having a diameter substantially equal to an outer diameter of annulus 26 or 27, and thus being able to mate with the respective annulus. Alternatively, the mounting is by some other means known in the art, such as by using an adhesive. A second labyrinth element 18 is mounted onto first element 16, the two elements forming a labyrinth which provides a path 34 for sound waves generated by disk 10, diaphragm 12, and cover 14 to traverse. Loudspeaker 8 is thus formed from actuator 36 or 37, comprising disk 10, diaphragm 12, and cover 14, and a labyrinth path section 38 comprising elements 16 and 18.

Actuators 36 and 37 vibrate when alternating voltages are applied to piezoelectric disk 10. In operation, the vibrations from the disk are transferred to diaphragm 12 and then to spherical section 24 and annulus 26 or 27 of the cover. The cover and annulus, having a significantly larger vibrating surface than diaphragm 12, act to substantially improve an efficiency of transfer of vibrations into path 34. Furthermore, the inventor has determined that plano-convex volume 28 acts as a resonant cavity which acts to enhance vibrations in a broad range of audio frequencies, further enhancing the efficacy of actuators 36 and 37.

It will be appreciated that actuators 36 and 37 act as transducers converting electrical signals to sound waves. It will also be appreciated that actuators 36 and 37 may perform energy conversion in the opposite direction, i.e., from sound wave energy to electrical energy, and thus act as an actuator of a microphone. It will thus be appreciated that loudspeaker 8 may act as a microphone.

Loudspeakers constructed as described hereinabove have a number of advantages. Each of the separate components may be easily produced, and the complete loudspeaker may be assembled from the component parts relatively quickly and simply. Furthermore, such loudspeakers, fabricated as described herein, will operate significantly more efficiently than piezoelectric loudspeakers or microphones which do not have covers such as cover 14.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A transducer, comprising:
a piezoelectric disk having a first diameter;
a diaphragm disk, fixed to the piezoelectric disk, the diaphragm disk having a second diameter greater than the first diameter; and
a cover, comprising a convex surface bounded by an annulus, which mates with the diaphragm disk to form a generally plano-convex volume between the diaphragm disk and the cover.

2. A transducer according to claim 1, wherein a cross-section of the annulus is substantially linear.

3. A transducer according to claim 1, wherein a cross-section of the annulus comprises a sinusoid.

4. A transducer according to claim 1, wherein the convex surface comprises an internal circumference, having a diameter substantially equal to the second diameter, and a groove formed along the internal circumference, and wherein the diaphragm disk is retained in contact with the cover by the groove.

5. A transducer according to claim 1, wherein the transducer is operative to convert electrical signals applied to the piezoelectric disk to sound waves radiated by the cover.

6. A transducer according to claim 1, wherein the transducer is operative to generate electrical signals from the piezoelectric disk responsive to sound waves incident on the cover.

7. A transducer according to claim 1, wherein the diaphragm disk is fixed substantially in parallel with and symmetrically to the piezoelectric disk.

8. A transducer according to claim 1, wherein the diaphragm disk, the piezoelectric disk, and the cover comprise a common axis of symmetry.

9. A loudspeaker, comprising:
a piezoelectric disk having a first diameter;
a diaphragm disk, fixed to the piezoelectric disk, the diaphragm disk having a second diameter greater than the first diameter;
a cover, comprising a convex surface bounded by an annulus, which mates with the diaphragm disk to form a generally plano-convex volume between the diaphragm disk and the cover; and
a labyrinth, which is fixedly coupled to a circumference of the annulus, and which is operative to provide a path for sound waves.

10. A loudspeaker according to claim 9, wherein a cross-section of the annulus is substantially linear.

11. A loudspeaker according to claim 9, wherein a cross-section of the annulus comprises a sinusoid.

12. A loudspeaker according to claim 9, wherein the convex surface comprises an internal circumference, having a diameter substantially equal to the second diameter, and a groove formed along the internal circumference, and wherein the diaphragm disk is retained in contact with the cover by the groove.

13. A loudspeaker according to claim 9, wherein the piezoelectric disk is operative to convert electrical signals applied thereto to sound waves, and wherein the sound waves are radiated by the cover.

14. A loudspeaker according to claim 9, wherein the piezoelectric disk is operative to generate electrical signals responsive to sound waves incident on the cover, so that the loudspeaker acts as a microphone.

15. A loudspeaker according to claim 9, wherein the diaphragm disk is fixed substantially in parallel with and symmetrically to the piezoelectric disk.

16. A loudspeaker according to claim 9, wherein the diaphragm disk, the piezoelectric disk, the cover, and the labyrinth comprise a common axis of symmetry.

17. A method for converting between sound and electrical energy, comprising:
providing a piezoelectric disk having a first diameter;
fixing a diaphragm disk to the piezoelectric disk, the diaphragm disk having a second diameter greater than the first diameter; and
mating a cover, comprising a convex surface bounded by an annulus, with the diaphragm disk to form a generally plano-convex volume between the diaphragm disk and the cover.

18. A method according to claim 17, wherein the convex surface comprises an internal circumference, having a diameter substantially equal to the second diameter, and a groove formed along the internal circumference, the method further comprising retaining the diaphragm disk in contact with the cover by the groove.

19. A method for forming a loudspeaker, comprising:
providing a piezoelectric disk having a first diameter;
fixing a diaphragm disk to the piezoelectric disk, the diaphragm disk having a second diameter greater than the first diameter;
mating a cover, comprising a convex surface bounded by an annulus, with the diaphragm disk to form a generally plano-convex volume between the diaphragm disk and the cover; and
fixedly coupling a labyrinth to a circumference of the annulus, the labyrinth being operative to provide a path for sound waves.

20. A method according to claim 19, wherein the convex surface comprises an internal circumference, having a diameter substantially equal to the second diameter, and a groove formed along the internal circumference, the method further comprising retaining the diaphragm disk in contact with the cover by the groove.

21. A method according to claim 19, wherein fixedly coupling the labyrinth comprises forming a labyrinth groove in the labyrinth, and retaining the annulus in the labyrinth groove.
